(19) United States
(12) Patent Application Publication
(10) Pub. No.: US 2007/0021302 A1
(43) Pub. Date: Jan. 25, 2007

(54) Optical disk and manufacturing method therefor

(75) Inventors: Ryuta Homma, Ibaraki (JP); Hideki Nagano, Ibaraki (JP); Yota Matsuki, Ibaraki (JP); Hiroshi Obara, Ibaraki (JP); Hidekaru Doi, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/486,097

(22) Filed: Jul. 14, 2006

(30) Foreign Application Priority Data
Jul. 14, 2005 (JP) 2005-205647
Aug. 10, 2005 (JP) 2005-232405

(51) Int. Cl. B41M 5/035

(52) U.S. Cl. 503/227

(57) ABSTRACT

The surface layer of a receptive layer has a water-absorbing property, and when the surface layer of the receptive layer is glossy and a layer to be printed covers up to a clamp area, the medium has a high possibility of causing a sticking of the receptive layer to a chucking mechanism in a drive. For this reason, an optical disk has been demanded which does not cause the peeling of the receptive layer in the clamp area while being used as the medium, provides a clear printed image, and copes with a high-resolution wide printing. In order to make the surface of the receptive layer not stick to the chucking mechanism of the drive, it is necessary to roughen the surface, but when a colored fine particle is contained in the receptive layer, a printed image on the receptive layer becomes unclear. Then, it was found that it is effective to add acrylic beads with an average particle diameter of ½ or larger of the thickness of the receptive layer into the receptive layer, in order to improve the adhesiveness of the beads to a particle absorbent and a macromolecule absorbent used in the receptive layer, reinforce the receptive layer, and realize a clear printed image.

### BACKGROUND OF THE INVENTION

The present invention relates to an optical disk on the surface of which an image can be printed, and further specifically relates to the optical disk on the surface of which a photograph-quality image having glossiness can be printed.

In the field of a practically used recordable optical disks such as CD-R and DVD-R, there is an optical disks of a type having a region to be printed thereon formed on the side opposite to the light-incoming side of the optical disk, through providing an ink-receptive layer, so that a user can easily print a title or a content of data recorded in the optical disk on the surface, by use of an ink jet printer for home use.

These optical disks have a clamp area for fixing and rotationally driving the optical disk provided around a disk center hole in a recording and reproducing unit, so that when an image such as a photograph taken with a digital camera is printed on a region to be printed, one part of the image is not printed at a site such as the disk center hole and the clamp area around it, on which a receptive layer is not provided. However, recently, an optical disk so-called capable of being widely printed has become commercially practical which has the region to be printed widened up to an internal circumference part by providing the receptive layer over the clamp area up to the proximity of the disk center hole, as is described in JP-A-2004-253071 (patent document 1), in order to reduce an unprinted part of the photographer image.

On the other hand, an optical disk has also become commercially practical which imparts the receptive layer glossiness so as to suit for printing a high-resolution photographic image, as is described in JP-A-2004-030716 (patent document 2).

An optical disk having a receptive layer which is formed in a region to be printed widened up to an internal circumference part and provided with glossiness so as to beautifully print a high-resolution image thereon is more suitable for printing an image such as a photograph on the optical disk thereon than the optical disk having the conventional region to be printed formed thereon.

However, it has been found that the optical disk having a conventionally used receptive layer provided with glossiness prepared over a clamp area up to the internal circumference part around a center hole causes the sticking of the receptive layer to a chucking mechanism of a drive and cannot be taken out, or causes the peeling of the receptive layer in the clamp area, while being repeatedly inserted into and ejected from a recording and reproducing unit, and consequently cannot save the printed image.

As a result of having studied the reason, it has been found that the smoother is the surface of a film, the more likely the clamp area part sticks to the chucking mechanism of the drive. Normally, the receptive layer is prepared on an underlayer, and a receptive layer having glossiness so as to cope with high-resolution printing needs to have low surface roughness in order to acquire glossiness. The receptive layer having glossiness also needs to receive a larger amount of the ink than a normal one does, and consequently needs to have a structure capable of absorbing a large amount of a solvent, especially water, contained in a printing ink. Thereby, the receptive layer having absorbed water becomes soft and sticky. The phenomenon is noticeably seen in a condition of high temperature and high humidity.

Accordingly, an object of the present invention is to provide an optical disk which has the receptive layer with glossiness prepared up to the vicinity of the center hole of the optical disk, but does not make the clamp area stick to a chucking mechanism of a drive even when being repeatedly used in a recording and reproducing unit.

A conventional optical disk of a so-called matte-type capable of being widely printed does not cause sticking of a receptive layer to a chucking mechanism of a drive and the peeling of the receptive layer in a clamp area, even when having been repeatedly used. The receptive layer of the matte-type employs, as a granular absorbent, mainly, fine inorganic particles such as SiO₂ or fine organic particles such as protein powder, but these fine particles need to be large so as to show an efficient effect of absorbing water, and consequently acquires large surface roughness.

The receptive layer with large surface roughness has a contact area or a bonding force between its surface and a clamp part reduced, and accordingly hardly causes sticking to a clamp area. However, when having large surface roughness, the receptive layer generally has low glossiness; and in addition, SiO₂ causes scattered reflection due to fine roughness between particles and on the surface of the receptive layer, and a protein powder does not have optical transparency, so that it is difficult for them to impart the receptive layer glossiness. In other words, there is a tradeoff relationship between surface properties and glossiness.

Then, as a result of having variously examined the material of fine particles, it was found that the receptive layer having employed beads of a transparent acrylic resin can roughen its surface while keeping glossiness. The reason is considered to be because the use of a transparent resin as the fine particle reduces the scattering and absorption of light in the receptive layer, and enables the light to be efficiently used. Accordingly, it became clear that an optical disk having the receptive layer using the acrylic beads formed of the transparent resin instead of the fine inorganic particle formed over the clamp area of the optical disk up to the vicinity of a center hole does not cause the sticking of the receptive layer to a chucking mechanism of a drive or the peeling of the receptive layer in a clamp area, and can make a high-resolution image with glossiness be printed thereon.

### SUMMARY OF THE INVENTION

According to a first aspect of the present invention, there is provided an optical disk comprising a recording layer, a reflective layer, an underlayer and a receptive layer with glossiness capable of receiving print provided on a substrate in this order, wherein the underlayer and the receptive layer among them cover a part up to a clamp area, and the receptive layer at least in the clamp area has acrylic beads having an average particle diameter equal to or larger than the thickness of the receptive layer but twice or less of the thickness of the receptive layer, and the acrylic beads uniformly distributed. The acrylic beads can adequately roughen the surface of the receptive layer, reduces the sticking of the receptive layer to the clamp part of a drive and can prevent the receptive layer from being peeled off, by having a certain size, that is, having the average particle diameter equal to or larger than the thickness of the receptive layer but twice or less.

According to a second aspect of the present invention provides an optical disk having acrylic beads with an average particle diameter equal to or larger than the thickness of a receptive layer but twice or less of the thickness of the receptive layer, and the acrylic beads uniformly distributed on the whole surface of the receptive layer. The optical disk can make an image uniformly printed on the whole surface, because the acrylic beads are uniformly distributed on the whole surface of the receptive layer.

A third aspect according to the present invention provides an optical disk comprising a receptive layer with glossiness capable of receiving print prepared on a side of a substrate opposite to the light-incoming side of the optical disk, and an underlayer between the substrate and the receptive layer, wherein the underlayer and the receptive layer among them cover a part up to a clamp area, and the receptive layer at least in the clamp area has acrylic beads having an average particle diameter equal to or larger than the thickness of the receptive layer but twice or less of the thickness of the receptive layer, and the acrylic beads uniformly distributed. As in a first aspect according to the present invention, the acrylic beads can adequately roughen the surface of the receptive layer, reduces the sticking of the receptive layer to the clamp part of a drive and can prevent the receptive layer from being peeled off, by having a certain size, that is, having an average particle diameter equal to or larger than the thickness of the receptive layer but twice it or less.

A fourth aspect according to the present invention, as in the second aspect, provides an optical disk having acrylic beads having an average particle diameter equal to or larger than the thickness of a receptive layer but twice it or less uniformly distributed further on the whole surface of the receptive layer. The optical disk can make an image uniformly printed on the whole surface, because the acrylic beads are uniformly distributed on the whole surface of the receptive layer.

In a fifth aspect of the present invention, a material of the transparent resin beads may be a resin having a high transparency and a refractive index equal to or close to that of the resin for the receptive layer; and such a resin includes, for instance, polyacrylic ester, polymethyl methacrylate, cross-linked polystyrene, cross-linked polyethyl methacrylate, polyethylene, ethylene-acrylic acid copolymer and ethylene-vinyl acetate copolymer.

A sixth aspect according to the present invention provides an optical disk, wherein the amount of the transparent resin beads in a paint for forming the receptive layer is 1.5 wt % or more but 4 wt % or less. When an amount of the added acrylic beads is increased, the receptive layer deteriorates its printing receptively though keeping its glossiness. In contrast, when the amount of the added acrylic beads is small, the receptive layer tends to cause sticking to the chucking mechanism of a drive, because the surface roughness becomes close to that of a conventional one. Accordingly, the amount of the added acrylic beads should be adequately controlled preferably to 2 wt % or more but 3 wt % or less.

A seventh aspect according to the present invention provides an optical disk in which the surface of the clamp area further has a ten point height of irregularities of 1.2 μm or more but 2.0 μm or less, and an arithmetic mean roughness of 0.3 μm or more but 0.8 μm or less. The receptive layer does not stick to a chucking mechanism through containing acrylic beads and controlling the surface roughness to 1.2 μm or more but 2.0 μm or less, and can keep glossiness through controlling the arithmetic mean roughness to 0.3 μm or more but 0.8 μm or less.

An eighth aspect according to the present invention provides an optical disk having a thickness of a receptive layer of 5 μm or thicker but 50 μm or thinner. The thickness is further preferably 5 to 20 μm. When the receptive layer has a thickness less than 5 μm, it may fail to absorb all of a solvent in an ink and may cause bleeding in a printed image. On the other hand, when the receptive layer has the thickness of 50 μm or thicker, the increased thickness may largely increase drying heat and a drying period of time, which are drying conditions in preparing a film, consequently may degrade the performance of the optical disk because of giving heat to a layer other than the receptive layer, and may increase a processing period of time for preparing the film.

A ninth aspect of the present invention provides a method for manufacturing an optical disk, the method comprising the steps of: applying a resin solution containing transparent resin beads; and curing the resin solution to form a receptive layer containing transparent resin beads therein. The method can easily form the receptive layer having an objective function, by applying the resin solution containing the transparent resin beads, and curing the resin solution.

In a tenth aspect of the present invention, the receptive layer is formed preferably by the steps of: employing a solution of a thermosetting resin as a resin solution; and thermally setting the resin solution. As for a resin component, a usable thermosetting resin may be a well-known resin used for an optical disk, from the viewpoint of weather resistance and durability, and generally includes an epoxy resin, a phenol resin, a melamine resin and a silicone resin. As a monomer for forming the thermosetting resin, there may be employed, for instance, an epoxy group-containing monomer such as glycidyl (meth)acrylate, (meta)allyl glycidyl ether, 1-allyloxy-3,4-epoxybutane and 1-(3-butenyloxy)-2,3-epoxypropane; and a monomer containing a hydrolysis-condensable group like a silyl group, such as vinyl trimethoxysilane, vinyl triethoxysilane, vinyltributoxysilane, vinylmethoxydimethysilane and vinylethoxydimethylsilane.

In an eleventh aspect of the present invention, the receptive layer is preferably formed by the steps of: using a solution of a photo-curing resin as a resin solution; and photo-curing the resin solution by use of photoinitiator. The photo-curing resin includes, for instance, ethyleneglycolmonomethylether (meth)acrylate, ethyleneglycolmonoethylether (meth)acrylate, diethyleneglycolmonoethylether (meth)acrylate, triethyleneglycolmonomethylether (meth)acrylate, ethyleneglycol di(meth)acrylate, diethyleneglycol di(meth)acrylate, triethyleneglycol di(meth)acrylate, ethyleneglycol-denatured trimethylolpropane tri(meth)acrylate, ethyleneglycol-denatured pentaerythritol tri(meth)acrylate, hydroxyethyl (meth)acrylate, hydroxypropyl (meth)acrylate and hydroxybutyl (meth)acrylate; and the photoinitiator includes, for instance, benzoin isopropylether, benzophenone, 2-hydroxy-2-methylpropiophenone, 1-hydroxycyclohexylphenylketone, 2,4-diethylthioxanthone, o-methylbenzoyl benzoate, 4,4-bisdiethylaminobenzophenone and 2,2-diethoxyacetophen.

By adding the acrylic beads as described above into the receptive layer, there can be attained an optical disk wherein adequate roughness is imparted to the surface of the receptive layer, sticking to a chucking mechanism of a drive is prevented, and the receptive layer has glossiness.

### BRIEF DESCRIPTION OF DRAWINGS

FIG. 1 is a top view and a sectional view of an optical disk according to the present invention;

FIG. 2 shows a relationship between a ratio of a diameter of a bead to a thickness of a receptive layer in Table 1 and specular gloss;

FIG. 3 shows a relationship between an amount of added beads and surface roughness in Table 2; and

FIG. 4 shows a relationship between ten point height of irregularities and arithmetic mean roughness in Table 3.

### DESCRIPTION OF REFERENCE NUMERALS

1: optical disk

2: transparent substrate

3: recording layer

4: reflective film

5: adhesive layer

6: dummy substrate

7: underlayer

8: receptive layer

9: clamp area

10: disk center hole

### DETAILED DESCRIPTION OF THE INVENTION

The present invention will be described in more detail with reference to the drawings.

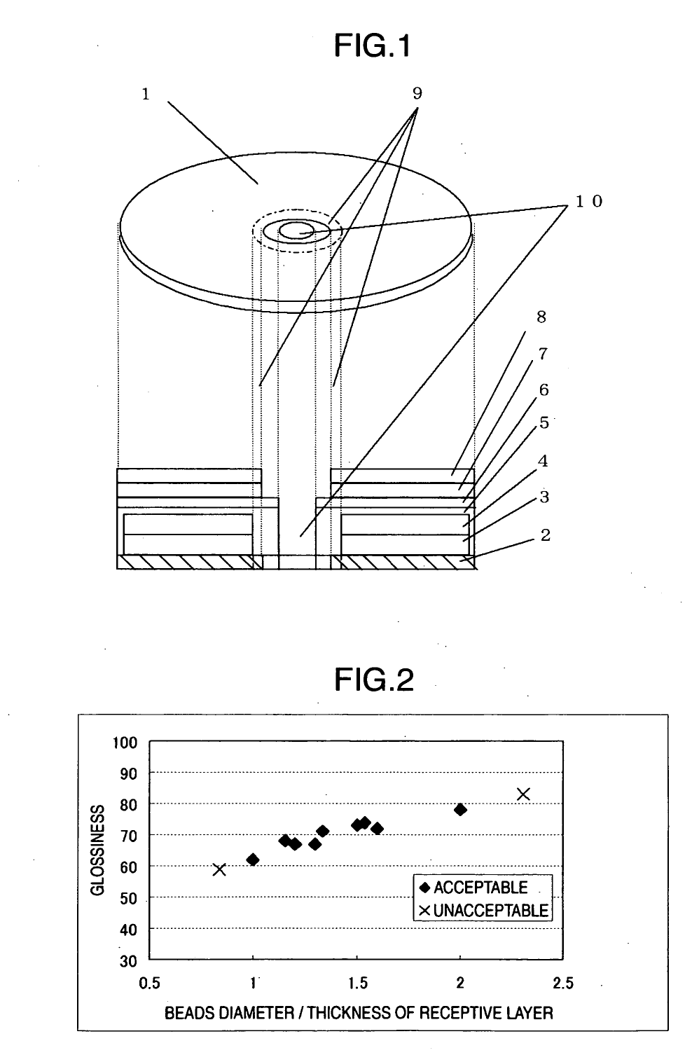

FIG. 1 shows a cross-sectional structure of an optical disk 1 according to Example of the present application. As is clear from the figure, the optical disk 1 according to the present example is formed by the steps of: preparing a recording film 3 and a reflecting film 4 on a transparent substrate 2; covering the surface of the reflecting film 4 with an adhesive layer 5; bonding a dummy substrate 6 to it; and forming an underlayer 7 and a receptive layer 8 on the dummy substrate.

The transparent substrate 2 is formed into a desired shape and size from a transparent ceramic material such as glass, or a transparent resin material such as polycarbonate resin, a polymethyl methacrylate resin, a polymethyl pentene resin, a polyolefin resin and an epoxy resin. The recording bodies 3 and 4 can be formed by well-known technologies, and are not gists of the present invention, so that the detailed description is omitted. Those can be formed by applying an appropriate well-known technology according to a type of the optical disk.

The underlayer 7 is generally formed of an UV ink which employs an ultraviolet-curing type resin as a binder. The underlayer 7 can be formed by a screen printing method, a spray coating method, a spin coating method or the like.

The receptive layer 8 may be made from a mixture of a high molecular compound having many hydrophilic groups and transparent resin beads.

The hydrophilic group contained in the receptive layer 8 includes, for instance, an anionic group such as a carboxyl group and a sulfonic group; a cationic group such as a quaternary ammonium group and an amphoteric amino group; and a nonionic hydrophilic group such as polyoxyl.

The transparent resin beads to be used here have an average particle diameter equal to or larger than the thickness of the receptive layer but twice it or less.

The thickness of the receptive layer 8 is controlled to 5 μm or larger but 50 μm or smaller, so as not to reduce the ink-absorbing capacity of an ink solvent and distort a medium itself. The receptive layer 8 can be formed by applying the high molecular compound having the hydrophilic group with a spin coater, a roll coater, a bar coater or the like. It is also possible to form the receptive layer, by dissolving the high molecular compound having the hydrophilic group in water, an organic solvent or the mixed solvent thereof, applying it and drying, in order to increase the smoothness of the surface of the receptive layer.

### EXAMPLE 1

### Relationship Between Bead Diameter and Thickness of Receptive Layer

(Sample A)

A recording layer 3 with the thickness of 150 nm was formed on a signal surface of a transparent substrate 2 with the thickness of 0.6 mm made from polycarbonate by spin-coating a coloring matter dissolved in tetrafluoropropanol. A reflective layer 4 made from a silver alloy was layered thereon by sputtering.

The surface of the reflective film 4 was spin-coated with an ultraviolet-curing adhesive, a dummy substrate with the same shape as the discoid transparent substrate 2 made from polycarbonate was laminated thereon, and then the adhesive was cured by being irradiated with an ultraviolet light of a high-pressure mercury lamp from a dummy substrate side.

Subsequently, a white underlayer 7 was formed on the surface of a region between a radius of 10 mm and a radius of 59 mm in the dummy substrate 6, by fixing a white UV link with a screen printing method and irradiating it with ultraviolet light.

A receptive layer 8 with the thickness of 10 μm was formed on the underlayer 7 in a region between a radius of 10 mm and a radius of 59 mm, by applying and fixing an ink for a receptive layer containing 3 wt % acrylic beads with the average particle diameter of 12 μm on the underlayer and drying it at 65° C. for 10 minutes, and thus, an optical disk having a cross-sectional structure shown in FIG. 1 was completed.

(Printing)

An image was printed on a receptive layer of a prepared optical disk with the use of an ink jet printer (PIXUS iP 8600 manufactured by Canon Co. Ltd.), and thus, the optical disk 1 having the image printed on the whole surface of the receptive layer 8 was formed.

(Evaluation Method)

Table 1 shows the results of a thickness of a receptive layer on a prepared optical disk, surface roughnesses of the receptive layer by a ten point height of irregularities and by arithmetic mean roughness, a sticking test of an image-printed receptive layer to a clamp, evaluation for glossiness and evaluation for a printing receptivity.

The thickness of the receptive layer was measured at a 4 cm distant part from the center of the optical disk 1.

The surface roughness was measured at ten points randomly selected on the surface of the receptive layer with the use of SEF-10A manufactured by Kosaka Laboratory, and an arithmetically averaged surface roughness of the measured values and arithmetic mean roughness were adopted for evaluation.

A sticking property to a clamp area was evaluated, by preserving the above described optical disk 1 having the image printed thereon in an atmosphere at 45° C. with the humidity of 80% for 20 hours, loading it once in a commercially available drive, and examining the sticking state of the receptive layer to the clamp of the drive. In the tables, “O” denotes that sticking property is good and “X” denotes that sticking properly is bad.

The glossiness of the surface of the receptive layer right before being printed was measured by a 60° specular gloss measuring method. In Table 1, glossiness is evaluated with good (O) for a specular gloss of 30 or higher and poor (X) for a specular gloss of less than 30.

The printing receptivity was evaluated with good (O) for a clear print of the printed image and poor (X) for an unbeautiful print having bleeding or the like.

In FIGS. 2 to 4, the value satisfying claims is evaluated to the acceptable, and the other value is evaluated to be unacceptable.

(Sample B)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 15 μm.

(Sample C)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 13 μm.

(Sample D)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 10 μm.

(Sample E)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 7.5 μm.

(Sample F)

An optical disk was prepared with the same method as in the case of Sample A, except that a conditioned ink containing 2.5 wt % acrylic beads with the average particle diameter of 20 μm for a receptive layer was applied on an underlayer so as to form a film with the thickness of 15 μm.

(Sample G)

An optical disk was prepared with the same method as in the case of Sample A, except that a conditioned ink containing 2.5 wt % acrylic beads with the average particle diameter of 20 μm for a receptive layer was applied on an underlayer so as to form a film with the thickness of 13 μm.

(Sample H)

An optical disk was prepared with the same method as in the case of Sample A, except that a conditioned ink containing 3 wt % acrylic beads with the average particle diameter of 20 μm for a receptive layer was applied on an underlayer so as to form a film with the thickness of 15 μm.

(Sample I)

An optical disk was prepared with the same method as in the case of Sample A, except that a conditioned ink containing 3 wt % acrylic beads with the average particle diameter of 20 μm for a receptive layer was applied on an underlayer so as to form a film with the thickness of 13 μm.

(Sample a)

An optical disk was prepared with the same method as in the case of Sample A, except that a conditioned ink containing acrylic beads with the average particle diameter of 15 μm in a changed amount of 2.5 wt % for a receptive layer was applied on an underlayer so as to form a film with the thickness of 18 μm.

(Sample b)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 6.5 μm.

### EXAMPLE 2

### Relationship Between Amount of Added Transparent Resin Beads and Surface Roughness

(Sample J)

An optical disk was prepared with the same method as in the case of Sample A, except that a conditioned ink containing 1.5 wt % acrylic beads with the average particle diameter of 15 μm for a receptive layer was applied on an underlayer so as to form a film with the thickness of 13 μm.

(Sample K)

An optical disk was prepared with the same method as in the case of Sample A, except that a conditioned ink containing 1.2 wt % acrylic beads with the average particle diameter of 15 μm for a receptive layer was applied on an underlayer so as to form a film with the thickness of 13 μm.

(Sample d)

An optical disk was prepared with the same method as in the case of Sample A, except that a conditioned ink containing 4.5 wt % acrylic beads with the average particle diameter of 15 μm for a receptive layer was applied on an underlayer so as to form a film with the thickness of 13 μm.

### EXAMPLE 3

### Relationship Between Arithmetic Mean Roughness Ra and Ten Point Height of Irregularities Rz

(Sample C)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 13 μm.

(Sample N)

An optical disk was prepared with the same method as in the case of Sample A, except that a conditioned ink containing 4 wt % acrylic beads with the

An optical disk was prepared with the same method as in the case of Sample A, except that a conditioned ink containing 2 wt % acrylic beads with the average particle diameter of 15 μm for a receptive layer was applied on an underlayer so as to form a film with the thickness of 13 μm.

(Sample L)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 13 μm.

(Sample M)

An optical disk was prepared with the same method as in the case of Sample A, except that a conditioned ink containing 3 wt % acrylic beads with the average particle diameter of 15 μm for a receptive layer was applied on an underlayer so as to form a film with the thickness of 13 μm.

(Sample N)

An optical disk was prepared with the same method as in the case of Sample A, except that a conditioned ink containing 4 wt % acrylic beads with the average particle diameter of 15 μm for a receptive layer was applied on an underlayer so as to form a film with the thickness of 13 μm.

(Sample c) average particle diameter of 15 μm for a receptive layer was applied on an underlayer so as to form a film with the thickness of 13 μm.

(Sample O)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 11 μm.

(Sample P)

An optical disk was prepared with the same method as in the case of Sample A, except that a conditioned ink containing 3 wt % acrylic beads with the average particle diameter of 15 μm for a receptive layer was applied on an underlayer so as to form a film with the thickness of 10 μm.

(Sample Q)

An optical disk was prepared with the same method as in the case of Sample A, except that a conditioned ink containing 2.5 wt % acrylic beads with the average particle diameter of 40 μm for a receptive layer was applied on an underlayer so as to form a film with the thickness of 30 μm.

(Sample c)

An optical disk was prepared with the same method as in the case of Sample A, except that a conditioned ink containing 1.2 wt % acrylic beads with the average particle diameter of 15 μm for a receptive layer was applied on an underlayer so as to form a film with the thickness of 13 μm.

(Sample d)

An optical disk was prepared with the same method as in the case of Sample A, except that a conditioned ink containing 4.5 wt % acrylic beads with the average particle diameter of 15 μm for a receptive layer was applied on an underlayer so as to form a film with the thickness of 13 μm.

(Sample e)

An optical disk was prepared with the same method as in the case of Sample A, except that a commercially available glossy wide printable disk was used, and was subjected to measurement and evaluation.

(Sample f)

An optical disk was prepared with the same method as in the case of Sample A, except that a resin of a glossless matte type containing fine inorganic particles of SiO₂ instead of transparent resin beads was used for a receptive layer, and was subjected to measurement and evaluation.

(Sample g)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 18 μm.

(Sample h)

An optical disk was prepared with the same method as in the case of Sample A, except that a conditioned ink containing 1.5 wt % acrylic beads with the average particle diameter of 20 μm for a receptive layer was applied on an underlayer so as to form a film with the thickness of 20 μm.

(Sample i)

An optical disk was prepared with the same method as in the case of Sample A, except that a conditioned ink containing 2 wt % acrylic beads with the average particle diameter of 20 μm for a receptive layer was applied on an underlayer so as to form a film with the thickness of 8 μm.

### EXAMPLE 4

### Relationship Between Thickness of Receptive Layer and Printing Receptively

(Sample R)

An optical disk was prepared with the same method as in the case of Sample A, except that a conditioned ink containing 3 wt % acrylic beads with the average particle diameter of 10 μm for a receptive layer was applied on an underlayer so as to form a film with the thickness of 5 μm.

(Sample S)

An optical disk was prepared with the same method as in the case of Sample A, except that a conditioned ink containing 3 wt % acrylic beads with the average particle diameter of 15 μm for a receptive layer was applied on an underlayer so as to form a film with the thickness of 10 μm.

(Sample T)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 13 μm.

(Sample U)

An optical disk was prepared with the same method as in the case of Sample A, except that a conditioned ink containing 2.5 wt % acrylic beads with the average particle diameter of 20 μm for a receptive layer was applied on an underlayer so as to form a film with the thickness of 15 μm.

(Sample Q)

An optical disk was prepared with the same method as in the case of Sample A, except that a conditioned ink containing 2.5 wt % acrylic beads with the average particle diameter of 40 μm for a receptive layer was applied on an underlayer so as to form a film with the thickness of 30 μm.

(Sample b)

An optical disk was prepared with the same method as in the case of Sample A, except that a conditioned ink containing 2.5 wt % acrylic beads with the average particle diameter of 15 μm for a receptive layer was applied on an underlayer so as to form a film with the thickness of 6.5 μm.

(Sample j)

An optical disk was prepared with the same method as in the case of Sample A, except that a conditioned ink containing 2.5 wt % acrylic beads with the average particle diameter of 5 μm for a receptive layer was applied on an underlayer so as to form a film with the thickness of 3 μm.

(Sample k)

An optical disk was prepared with the same method as in the case of Sample A, except that a conditioned ink containing 2.5 wt % acrylic beads with the average particle diameter of 60 μm for a receptive layer was applied on an underlayer so as to form a film with the thickness of 53 μm.

(Evaluation for disk)

As is shown in Table 1, FIG. 2 and a result described below, Samples A to K of an optical disk according to the examples show a remarkable effect of preventing the sticking of the receptive layer to a clamp and keeps glossiness, because the acrylic bead has a size equal to or larger than a film thickness but twice the film thickness or less.

In contrast, Sample (a) containing acrylic beads with an average particle diameter equal to or smaller than the thickness of a receptive layer could not obtain sufficient surface roughness, and did not show the effect of preventing the receptive layer from sticking to a clamp.

As is shown in Sample (b), an optical disk having a receptive layer containing acrylic beads with an average particle diameter more than twice a thickness of the receptive layer could obtain sufficient surface roughness, but showed poor printing receptively, which was impractical.

In addition, an optical disk which has employed opaque beads such as synthetic mica and TiO₂ instead of the transparent resin beads passed a sticking test, but did not provide sufficient glossiness.

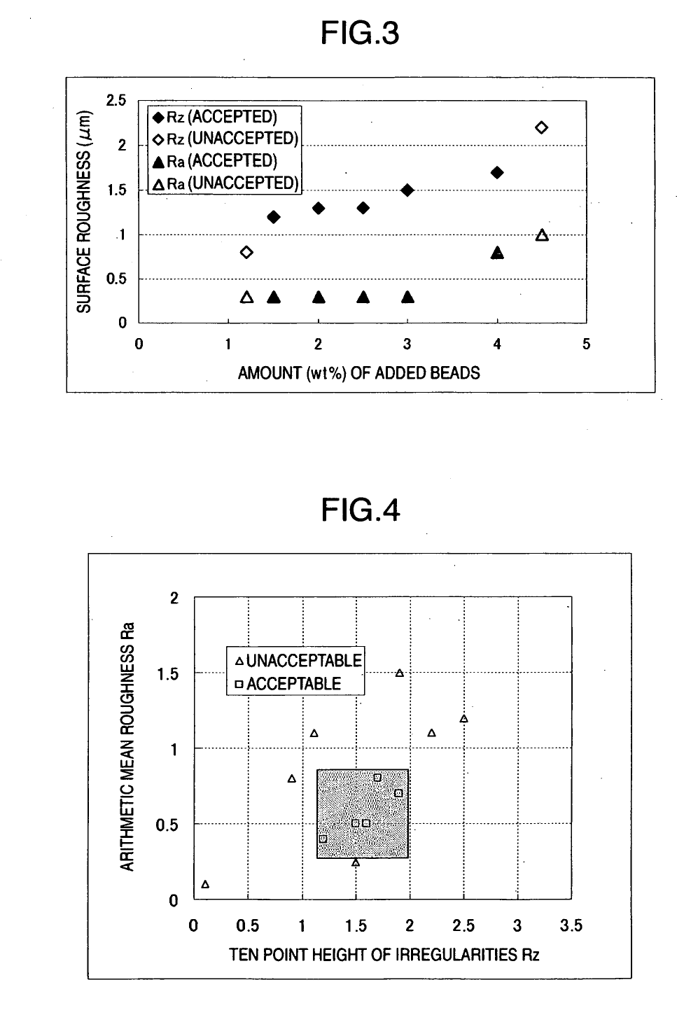

As is shown in Sample (c) of Table 2 and in FIG. 3, an optical disk having a receptive layer containing added beads in an amount of less than 1.5 wt % could not obtain sufficient surface roughness, and did not show the effect of preventing the receptive layer from sticking to a clamp.

As is shown in Sample (d) in Table 2, an optical disk having a receptive layer containing beads in an amount of more than 4 wt % could obtain sufficient surface roughness, but showed poor printing receptivity, which was impractical.

In addition, as is shown in Table 3, an optical disk having a ten point height of irregularities Rz smaller than a value described in claims shows an adequate printing receptively but tends to cause sticking, and an optical disk having a ten point height of irregularities Rz larger than the value described in claims hardly causes sticking but aggravates printing receptivity. An optical disk having an arithmetic mean roughness Ra smaller than a value described in claims shows an adequate printing receptivity and improved glossiness but tends to cause sticking, and an optical disk having an arithmetic mean roughness Ra larger than the value described in the claims hardly causes sticking but aggravates printing receptivity and lowers glossiness. When the receptive layer does not contain acrylic beads, the optical disk tends to make the receptive layer stick to a chucking mechanism of a drive.

In addition, as is shown in Table 4, when the receptive layer had a thickness of 5 μm or thinner, it cause bleeding because the receptive layer has small ink-absorption capacity, and when the receptive layer had a thickness of 50 μm or thicker, the increased thickness largely increased drying heat and a drying period of time, which are drying conditions in preparing a film, consequently degraded the performance of the optical disk because of giving heat to a layer other than the receptive layer, and increased a processing period of time for preparing the film.

Accordingly, in the present invention, an optical disk having the receptive layer with the thickness of 50 μm or thicker was not adopted from the viewpoint of the performance of the optical disk and the manufacturing process.

TABLE 1

| | Composition | | | Measurement result | | | | | |
|---|---|---|---|---|---|---|---|---|---|
| | | | Thickness | Ten point | Arithmetic | | | | |
| | | Amount | of | height of | mean | | Evaluation result | | |
| | Diameter | of added | receptive | irregularities | roughness | Specular | Sticking | | Printing |
| | of bead | beads | layer | Rz | Ra | gloss | property | Glossiness | receptivity |
| Sample A | 12 | 3 | 10 | 1.3 | 0.3 | 67 | ◯ | ◯ | ◯ |
| Sample B | 15 | 2.5 | 15 | 1 | 0.3 | 62 | ◯ | ◯ | ◯ |
| Sample C | 15 | 2.5 | 13 | 1.1 | 0.3 | 68 | ◯ | ◯ | ◯ |
| Sample D | 15 | 2.5 | 10 | 1.3 | 0.3 | 73 | ◯ | ◯ | ◯ |
| Sample E | 15 | 2.5 | 7.5 | 1.8 | 0.3 | 78 | ◯ | ◯ | ◯ |
| Sample F | 20 | 2.5 | 15 | 1.2 | 0.3 | 71 | ◯ | ◯ | ◯ |
| Sample G | 20 | 2.5 | 13 | 1.2 | 0.3 | 74 | ◯ | ◯ | ◯ |
| Sample H | 20 | 3 | 15 | 1.4 | 0.3 | 67 | ◯ | ◯ | ◯ |
| Sample I | 20 | 3 | 13 | 1.4 | 0.3 | 72 | ◯ | ◯ | ◯ |
| Sample a | 15 | 2.5 | 18 | 1.1 | 0.2 | 59 | X | ◯ | ◯ |
| Sample b | 15 | 2.5 | 6.5 | 2.2 | 0.3 | 83 | ◯ | ◯ | X |

TABLE 2

| | Composition | | | Measurement result | | | | | |
|---|---|---|---|---|---|---|---|---|---|
| | | | Thickness | Ten point | Arithmetic | | | | |
| | | Amount | of | height of | mean | | Evaluation result | | |
| | Diameter | of added | receptive | irregularities | roughness | Specular | Sticking | | Printing |
| | of bead | beads | layer | Rz | Ra | gloss | property | Glossiness | receptivity |
| Sample J | 15 | 1.5 | 13 | 1.2 | 0.3 | 73 | ◯ | ◯ | ◯ |
| Sample K | 15 | 2 | 13 | 1.3 | 0.3 | 70 | ◯ | ◯ | ◯ |
| Sample L | 15 | 2.5 | 13 | 1.3 | 0.3 | 68 | ◯ | ◯ | ◯ |
| Sample M | 15 | 3 | 13 | 1.5 | 0.3 | 64 | ◯ | ◯ | ◯ |
| Sample N | 15 | 4 | 13 | 1.7 | 0.8 | 59 | ◯ | ◯ | ◯ |
| Sample c | 15 | 1.2 | 13 | 0.8 | 0.3 | 75 | X | ◯ | ◯ |
| Sample d | 15 | 4.5 | 13 | 2.2 | 1 | 55 | ◯ | ◯ | X |

TABLE 3

| | Composition | | | Measurement result | | | | | |
|---|---|---|---|---|---|---|---|---|---|
| | | | Thickness | Ten point | Arithmetic | | | | |
| | | Amount | of | height of | mean | | Evaluation result | | |
| | Diameter | of added | receptive | irregularities | roughness | Specular | Sticking | | Printing |
| | of bead | beads | layer | Rz | Ra | gloss | property | Glossiness | receptivity |
| Sample C | 15 | 2.5 | 13 | 1.2 | 0.4 | 68 | ◯ | ◯ | ◯ |
| Sample N | 15 | 4 | 13 | 1.7 | 0.8 | 59 | ◯ | ◯ | ◯ |
| Sample O | 15 | 2.5 | 11 | 1.5 | 0.5 | 71 | ◯ | ◯ | ◯ |
| Sample P | 15 | 3 | 10 | 1.6 | 0.5 | 73 | ◯ | ◯ | ◯ |
| Sample Q | 40 | 2.5 | 30 | 1.9 | 0.7 | 77 | ◯ | ◯ | ◯ |
| Sample c | 15 | 1.2 | 13 | 0.8 | 0.9 | 75 | X | ◯ | ◯ |
| Sample d | 15 | 4.5 | 13 | 1.5 | 1.9 | 55 | ◯ | ◯ | X |
| Sample e | | | | 0.1 | 0.1 | 86 | X | ◯ | ◯ |
| Sample f | | | | 1.2 | 2.5 | 10 | ◯ | X | ◯ |
| Sample g | 15 | 2.5 | 18 | 1.1 | 1.1 | 59 | X | ◯ | ◯ |
| Sample h | 20 | 1.5 | 20 | 0.25 | 1.5 | 68 | X | ◯ | X |
| Sample i | 20 | 2 | 8 | 2.2 | 1.1 | 74 | ◯ | ◯ | X |

TABLE 4

| | Composition | | | Measurement result | | | | | |
|---|---|---|---|---|---|---|---|---|---|
| | | | Thickness | Ten point | Arithmetic | | | | |
| | | Amount | of | height of | mean | | Evaluation result | | |
| | Diameter | of added | receptive | irregularities | roughness | Specular | Sticking | | Printing |
| | of bead | beads | layer | Rz | Ra | gloss | property | Glossiness | receptivity |
| Sample R | 10 | 3 | 5 | 1.5 | 0.3 | 76 | ◯ | ◯ | ◯ |
| Sample S | 15 | 3 | 10 | 1.5 | 0.3 | 73 | ◯ | ◯ | ◯ |
| Sample T | 15 | 2.5 | 13 | 1.5 | 0.3 | 68 | ◯ | ◯ | ◯ |
| Sample U | 20 | 2.5 | 15 | 1.5 | 0.3 | 71 | ◯ | ◯ | ◯ |
| Sample Q | 40 | 2.5 | 30 | 1.9 | 0.7 | 77 | ◯ | ◯ | ◯ |
| Sample b | 15 | 2.5 | 5 | 2.2 | 0.3 | 83 | ◯ | ◯ | X |
| Sample j | 5 | 2.5 | 3 | 0.9 | 0.3 | 80 | X | ◯ | X |
| Sample k | 60 | 2.5 | 53 | — | — | — | ◯ | ◯ | X |

1. An optical disk comprising a recording layer, a reflective layer, an underlayer and a receptive layer with glossiness capable of receiving print provided on a substrate in this order, wherein the underlayer and the receptive layer cover a part up to a clamp area, and the receptive layer at least in the clamp area has transparent resin beads having an average particle diameter equal to or large than the thickness of the receptive layer but twice or less of the thickness of the receptive layer, and the transparent resin beads are uniformly distributed, and the surface of the receptive layer has a specular gloss of 30 or higher when the gloss is measured according to a 60° specular gloss measuring method specified in JIS Z 8741.

2. An optical disk according to claim 1, wherein the transparent resin beads having the average particle diameter equal to or larger than the thickness of the receptive layer but twice or less of the thickness of the receptive layer are uniformly distributed on the whole surface of the receptive layer.

3. An optical disk comprising a receptive layer with glossiness capable of receiving print provided on a side of substrate opposite to a light-incoming side, and an underlayer between the substrate and the receptive layer, wherein the underlayer and the receptive layer cover a part up to a clamp area, and the receptive layer at least in the clamp area has transparent resin beads having an average particle diameter equal to or larger than the thickness of the receptive layer but twice or less of the thickness of the receptive layer, and the transparent resin beads are uniformly distributed, and the surface of the receptive layer has a specular gloss of 30 or higher when the gloss is measured with a 60° specular gloss measuring method specified as JIS Z 8741.

4. An optical disk according to claim 3, wherein the transparent resin beads having an average particle diameter equal to or larger than the thickness of the receptive layer but twice or less of the thickness of the receptive layer are uniformly distributed on the whole surface of the receptive layer.

5. An optical disk according to any of claim 1-4, wherein the transparent resin bead used in the receptive layer is an acrylic bead.

6. An optical disk according to any of claims 1-4, wherein the amount of the transparent resin beads in a paint for forming the receptive layer is 1.5 wt % or more but 4 wt % or less.

7. An optical disk according to any of claims 1-4, wherein the surface of the clamp area has a ten point height of irregularities of 1.2 μm or more but 2.8 μm or less, and an arithmetic mean roughness of 0.3 μm or more but 0.9 μor less.

8. An optical disk according to any of claims 1-4, wherein the thickness of the receptive layer is 5 μm or larger but 50 μm or smaller.

9. A method for manufacturing the optical disk according to any of claims 1-4 comprising the steps of: applying a resin solution containing transparent resin beads; and curing the resin solution to form a receptive layer containing the transparent resin beads therein.

10. A method for manufacturing the optical disk according to claim 9, wherein the receptive layer containing the transparent resin beads is formed by the steps of: employing a solution of a thermosetting resin as the resin solution containing the transparent resin beads; and thermally setting the resin solution.

11. The method for manufacturing the optical disk according to claim 9, wherein the receptive layer containing the transparent resin beads is formed by the steps of: employing a solution of a photo-curing resin as the resin solution containing the transparent resin beads; and photo-curing the resin solution.
